(19) United States
(12) Patent Application Publication
(10) Pub. No.: US 2020/0091468 A1
(43) Pub. Date: Mar. 19, 2020

(54) DUAL POLARITY LID FOR BATTERY CELL OF AN ELECTRIC VEHICLE

(71) Applicant: SF Motors, Inc., Santa Clara, CA (US)

(72) Inventors: Derek Nathan Wong, Santa Clara, CA (US); Scott Quinlan Freeman Monismith, Santa Clara, CA (US); Jeremy Andrew Elsberry, Santa Clara, CA (US); Ying Liu, Santa Clara, CA (US)

(21) Appl. No.: 16/131,470

(22) Filed: Sep. 14, 2018

(51) Int. Cl. H01M 2/04; H01M 2/08; B60L 11/18

(52) U.S. Cl. CPC H01M 2/046; H01M 2/08; H01M 2/043; B60K 1/04; H01M 2/0486; B60L 11/1879; H01M 2/0482

(57) ABSTRACT

Provided herein is a battery cell of a battery pack to power an electric vehicle. The battery cell can include a housing and an electrolyte can be disposed in an inner region defined by the housing. A lid can couple with a first end of the housing. The lid can include a first polarity layer that can function as a first polarity terminal and can include a first polarity orifice and a scored region. The lid can include an insulating layer having a first insulated orifice and a second insulated orifice. The lid can include a second polarity layer having a protruding second polarity region that can function as a second polarity terminal and extends through the first insulated orifice and the first polarity orifice. A gasket can couple with edge surfaces of the first polarity layer, the second polarity layer, and the insulating layer.

### BACKGROUND

Batteries can include electrochemical materials to supply electrical power to various electrical components connected thereto. Such batteries can provide electrical energy to various electrical systems.

### SUMMARY

Systems and methods described herein relates to a battery cell of a battery pack of an electric vehicle. The battery cell can include a lid having both at least one positive terminal and at least one negative terminal to provide the both at least one positive terminal and the at least one negative terminal at a common end (e.g., top end) of the battery cell. For example, the lid can include a first polarity layer exposed at the first end of the battery cell and a cylindrical embossment of a second polarity and exposed at the first end of the battery cell. Thus, the lid of the battery cell can provide both a positive terminal and a negative terminal at the same end of the battery cell. Having both a positive terminal and a negative terminal at the same end of the battery cell can increase weldability to both terminals by increasing the welding surface area and providing an easily definable feature for the wire bonding machine optics to identify. This design may also remove the need to use the housing of the battery cell as a terminal of a first or second polarity and thus, opening the possibilities for new materials to use to form the housing of the battery cell.

At least one aspect is directed to a battery cell of a battery pack to power an electric vehicle. The battery cell can include a housing having a first end and a second end. The housing can define an inner region. An electrolyte can be disposed in the inner region defined by the housing. A lid can couple with a first end of the housing. The lid can include a first polarity layer having a first polarity orifice and a scored region. The lid can include an insulating layer having a first insulated orifice and a second insulated orifice. The lid can include a second polarity layer having a protruding second polarity region that extends through the insulated orifice of the insulating layer and the first polarity orifice of the first polarity layer. The second polarity region can include a second polarity orifice. The second polarity orifice can be aligned with the scored region of the first polarity layer and the second insulated orifice of the insulating layer. The insulating layer can be disposed between the first polarity layer and the second polarity layer to electrically insulate the first polarity layer from the second layer. A gasket can couple with edge surfaces of each of the first polarity layer, the second polarity layer, and the insulating layer. The gasket can hold the first polarity layer, the second polarity layer, and the insulating layer together.

At least one aspect is directed to a method of providing a battery cell of a battery pack to power an electric vehicle. The method can include providing a battery pack having a battery cell. The battery cell can include a housing that include a first end and a second end and defines an inner region. The method can include disposing an electrolyte in the inner region defined by the housing. The method can include coupling a lid with a first end of the housing. The method can include providing a first polarity layer having a first polarity orifice and a scored region. The method can include coupling an insulating layer with at least one surface of the first polarity layer, the insulating layer having a first insulated orifice and a second insulated orifice. The method can include coupling a second polarity layer with at least one surface of the insulating layer such that the insulating layer is disposed between the first polarity layer and the second polarity layer to electrically insulate the first polarity layer from the second layer. The method can include disposing a protruding second polarity region of second polarity layer through the first insulated orifice of the insulating layer and the first polarity orifice of the first polarity layer. The second polarity region can have a second polarity orifice. The method can include aligning the second polarity orifice of the second polarity region with the scored region of the first polarity layer and the second insulated orifice of the insulating layer. The method can include crimping at least one edge of a gasket over edges surfaces of each of the first polarity layer, the second polarity layer, and the insulating layer to couple the first polarity layer, the second polarity layer, and the insulating layer together.

At least one aspect is directed to a method. The method can include providing a battery cell of a battery pack of an electric vehicle. The battery cell can include a housing having a first end and a second end. The housing can define an inner region. An electrolyte can be disposed in the inner region defined by the housing. A lid can couple with a first end of the housing. The lid can include a first polarity layer having a first polarity orifice and a scored region. The lid can include an insulating layer having a first insulated orifice and a second insulated orifice. The lid can include a second polarity layer having a protruding second polarity region that extends through the insulated orifice of the insulating layer and the first polarity orifice of the first polarity layer. The second polarity region can include a second polarity orifice. The second polarity orifice can be aligned with the scored region of the first polarity layer and the second insulated orifice of the insulating layer. The insulating layer can be disposed between the first polarity layer and the second polarity layer to electrically insulate the first polarity layer from the second layer. A gasket can couple with edge surfaces of each of the first polarity layer, the second polarity layer, and the insulating layer. The gasket can hold the first polarity layer, the second polarity layer, and the insulating layer together.

At least one aspect is directed to an electric vehicle. The electric vehicle can include a battery cell of a battery pack of an electric vehicle. The battery cell can include a housing having a first end and a second end. The housing can define an inner region. An electrolyte can be disposed in the inner region defined by the housing. A lid can couple with a first end of the housing. The lid can include a first polarity layer having a first polarity orifice and a scored region. The lid can include an insulating layer having a first insulated orifice and a second insulated orifice. The lid can include a second polarity layer having a protruding second polarity region that extends through the insulated orifice of the insulating layer and the first polarity orifice of the first polarity layer. The second polarity region can include a second polarity orifice. The second polarity orifice can be aligned with the scored region of the first polarity layer and the second insulated orifice of the insulating layer. The insulating layer can be disposed between the first polarity layer and the second polarity layer to electrically insulate the first polarity layer from the second layer. A gasket can couple with edge surfaces of each of the first polarity layer, the second polarity layer, and the insulating layer. The gasket can hold the first polarity layer, the second polarity layer, and the insulating layer together.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting a cross-sectional view of an example battery cell for a battery pack in an electric vehicle, according to an illustrative implementation;

FIG. 2 is a side view of a lid of a battery cell for a battery pack in an electric vehicle, according to an illustrative implementation;

FIG. 3 is a top view of a lid of a battery cell for a battery pack in an electric vehicle, according to an illustrative implementation;

FIG. 4 is a cross-sectional view of a lid of a battery cell for a battery pack in an electric vehicle, according to an illustrative implementation;

FIG. 5 is a cross-sectional view of a scored region of a first polarity layer aligned with orifices formed in an insulating layer and a second polarity layer of a lid of a battery cell for a battery pack in an electric vehicle, according to an illustrative implementation;

FIG. 6 is a block diagram depicting a cross-sectional view of an example battery pack for holding battery cells in an electric vehicle;

FIG. 7 is a block diagram depicting a cross-sectional view of an example electric vehicle installed with a battery pack;

FIG. 8 is a flow diagram depicting an example method of providing a battery cell of a battery pack to power an electric vehicles; and

FIG. 9 is a flow diagram depicting an example method of providing battery cells for battery packs for electric vehicles.

### DETAILED DESCRIPTION

Following below are more detailed descriptions of various concepts related to, and implementations of battery cells for battery packs in electric vehicles. The various concepts introduced above and discussed in greater detail below can be implemented in any of numerous ways.

Systems and methods described herein relate to battery cell of a battery pack of an electric vehicle having a lid that provides at least one positive terminal and the at least one negative terminal at a common end of the battery cell. For example, the lid can include multiple layers in a stacked arrangement. A first layer can include an exposed surface at a first polarity and at least one of the other layers can include a protruding region that extends through the other layers to provide an exposed surface at a second polarity. Thus, the lid can include both a positive terminal and a negative terminal at a common end of the battery cell.

The lid can include a series of three layers (e.g., three disks) held together by an outer gasket that can be mechanically crimped around the three layers. The layers can include a first polarity layer and a second polarity layer separated by at least one insulating layer. The second polarity layer (or bottom layer) can include a cylindrical embossment formed on one portion of the second polarity layer and an orifice (e.g., a circular hole) positioned 180 degrees from the embossment on the second polarity layer. The insulating layer (or center layer) can act as an electrical insulator between the first polarity layer (e.g., top layer) and the second polarity layer (e.g., bottom layer). The insulating layer can include an insulated shaft region that is aligned with the cylindrical embossment of the second polarity layer.

The insulating layer can include multiple insulated orifices with a first insulated orifice aligned with the cylindrical embossment of the second polarity layer and a second insulated orifice positioned 180 degrees from the first insulated orifice and aligned with the orifice of the second polarity layer. The insulating layer can include one or more extrusions formed on the surfaces (e.g., top surface, bottom surface) of the insulating layer to provide an airtight seal between the different layers of the lid and between the insulated shaft region and the cylindrical embossment via compressive force. The extrusions of the insulating layer can prevent air ingress into the battery cell or leakage of internal components.

The first polarity layer can include an orifice aligned with the cylindrical embossment of the second polarity layer that the cylindrical embossment can extend through to provide a second polarity terminal at the first end of the battery cell. The cylindrical embossment can be electrically insulated from portions of the first polarity layer by the insulated shaft region positioned between the cylindrical embossment and portions of the first polarity layer. The first polarity layer can include a scored region positioned 180 degrees from the orifice of the first polarity layer. The scored region can operate as a vent during a thermal event or over pressurization of the battery cell. For example, the scored region can break an electrical connection between the battery cell and a busbar of a battery pack in response to a thermal event or over pressurization of the battery cell.

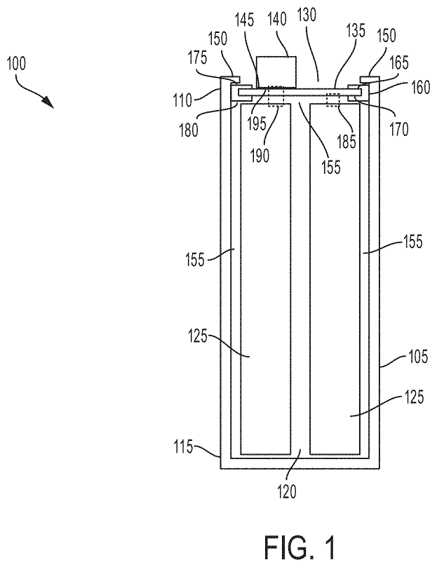

FIG. 1, among others, depicts a cross-sectional view of a battery cell 100 for a battery pack in an electric vehicle. The battery cell 100 can provide energy or store energy for an electric vehicle. For example, the battery cell 100 can be included in a battery pack used to power an electric vehicle. The battery cell 100 can include at least one housing 105. The housing 105 can have a first end 110 and a second end 115. The battery cell 100 can be a lithium-air battery cell, a lithium ion battery cell, a nickel-zinc battery cell, a zinc-bromine battery cell, a zinc-cerium battery cell, a sodium-sulfur battery cell, a molten salt battery cell, a nickel-cadmium battery cell, or a nickel-metal hydride battery cell, among others. The housing 105 can be included or contained in a battery pack (e.g., a battery array or battery module) installed a chassis of an electric vehicle. The housing 105 can have the shape of a cylindrical casing or cylindrical cell with a circular, ovular, or elliptical base, as depicted in the example of the battery cell of FIG. 1. A height of the housing 105 can be greater than a width of the housing 105. For example, the housing 105 can have a length (or height) in a range from 65 mm to 75 mm and a width (or diameter for circular examples) in a range from 17 mm to 25 mm. In some examples the width or diameter of the housing 105 can be greater than the length (e.g., height) of the housing 105. The housing 105 can be formed from a prismatic casing with a polygonal base, such as a triangle, square, a rectangular, a pentagon, or a hexagon, for example. A height of such a prismatic cell housing 105 can be less than a length or a width of the base of the housing 105. The battery cell 100 can be a cylindrical cell 21 mm in diameter and 70 mm in height. Other shapes and sizes are possible, such as a rectangular cells or rectangular cells with rounded edges, of cells between 17 mm to 25 mm in diameter or width, and 65 mm to 75 mm in length or height.

The housing 105 of the battery cell 100 can include at least one electrically or thermally conductive material, or combinations thereof. The electrically conductive material can also be a thermally conductive material. The electrically conductive material for the housing 105 of the battery cell 100 can include a metallic material, such as aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The electrically conductive material and thermally conductive material for the housing 105 of the battery cell 100 can include a conductive polymer. To evacuate heat from inside the battery cell 100, the housing 105 can be thermally coupled to a thermoelectric heat pump (e.g., a cooling plate) via an electrically insulating layer. The housing 105 can include an electrically insulating material. The electrically insulating material can be a thermally conductive material. The electrically insulating and thermally conductive material for the housing 105 of the battery cell 100 can include a ceramic material (e.g., silicon nitride, silicon carbide, titanium carbide, zirconium dioxide, beryllium oxide, and among others) and a thermoplastic material (e.g., polyethylene, polypropylene, polystyrene, or polyvinyl chloride), among others. To evacuate heat from inside the battery cell 100, the housing 105 can be thermally coupled to a thermoelectric heat pump (e.g., a cooling plate). The housing 105 can be directly thermally coupled to the thermoelectric heat pump without an addition of an intermediary electrically insulating layer.

The housing 105 of the battery cell 100 can include the first end 110 (e.g., top portion) and the second end 115 (e.g., bottom portion). The housing 105 can define an inner region 120 between the first end 110 and the second end 115. For example, the inner region 120 can include an interior of the housing 105 or an inner area formed by the housing 105. The first end 110, inner region 120, and the second end 115 can be defined along one axis of the housing 105. For example, the inner region 120 can have a width (or diameter for circular examples) of 2 mm to 6 mm and a length (or height) of 50 mm to 70 mm. The first end 110, inner region 120, and second end 115 can be defined along a vertical (or longitudinal) axis of cylindrical casing forming the housing 105. The first end 110 at one end of the housing 105 (e.g., a top portion as depicted in FIG. 1). The second end 115 can be at an opposite end of the housing 105 (e.g., a bottom portion as depicted in FIG. 1). The end of the second end 115 can encapsulate or cover the corresponding end of the housing 105.

At least one electrolyte 125 can be disposed in the inner region 120 of the housing 105. The battery cell 100 can include multiple electrolytes 125 disposed in the inner region 120 of the housing. The electrolyte 125 can include a first polarity electronic charge region or terminus and a second polarity electronic charge region or terminus. For example, the electrolyte 125 can include a positive electronic charge region or terminus and a negative electronic charge region or terminus. At least one second polarity tab 190 (e.g., negative tab) can couple a second polarity region of the electrolyte 125 (e.g., negative region of electrolyte 125) with the surface of the housing 105 or a second polarity layer 140 of a lid 130. For example, a second polarity region of the electrolyte 125 can couple with one or more surfaces of the housing 105 or a second polarity layer 140 of a lid 130, such as to form a second polarity surface area (e.g., negative surface area) on the lid 130 for second polarity wire bonding. A first polarity tab 185 (e.g., positive tab) can couple a first polarity region of the electrolyte with a first polarity layer 135 of the lid 130 to form a first polarity surface area (e.g., positive surface area) on the lid 130 for first polarity wire bonding. The electrolyte 125 can include any electrically conductive solution, dissociating into ions (e.g., cations and anions). For a lithium-ion battery cell, for example, the electrolyte 125 can include a liquid electrolyte, such as lithium bisoxalatoborate (LiBC4O8 or LiBOB salt), lithium perchlorate (LiClO4), lithium hexaflourophosphate (LiPF6), and lithium trifluoromethanesulfonate (LiCF3SO3). The electrolyte 125 can include a polymer electrolyte, such as polyethylene oxide (PEO), polyacrylonitrile (PAN), poly(methyl methacrylate) (PMMA) (also referred to as acrylic glass), or polyvinylidene fluoride (PVdF). The electrolyte 125 can include a solid-state electrolyte, such as lithium sulfide (Li2S), magnesium, sodium, and ceramic materials (e.g., beta-alumna). A single electrolyte 125 can be disposed within inner region 120 of the housing 105 or multiple electrolytes 125 (e.g., two electrolytes, more than two electrolytes) can be disposed within inner region 120 of the housing 105. For example, two electrolytes 125 can be disposed within inner region 120 of the housing 105. The number of electrolytes 125 can vary and can be selected based at least in part on a particular application of the battery cell 100.

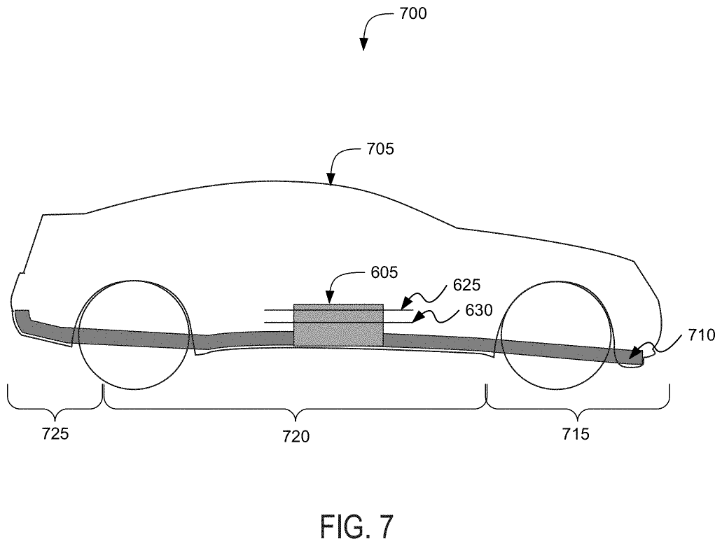

At least one lid 130 can be disposed proximate to the first end 110 of the housing 105. The lid 130 can be disposed onto the first lateral end 110 of the housing 105. The lid 130 can include a first polarity layer 135 (e.g., positive layer) and a second polarity layer 140 (e.g., negative layer). The first polarity layer 135 can operate as a first polarity terminal (e.g., positive terminal) of the battery cell 100. The second polarity layer 140 can operate as a second polarity terminal (e.g., negative terminal) of the battery cell 100. For example, the battery cell 100 can couple with a first polarity busbar and a second polarity busbar (e.g., positive and negative busbars, positive and negative current collectors) of a battery pack of an electric vehicle through the first polarity layer 135 and the second polarity layer 140 of the lid 130 (as shown in FIG. 7). Via a module tab connection (or other techniques such as wire bonding of a wire), the first polarity layer 135 and the second polarity layer 140 of the lid 130 can couple the battery cell 100 with busbars of the battery pack from the same end or common end (e.g., top or bottom) or from longitudinal sides of the battery cell 100. The battery pack can be disposed in an electric vehicle to power a drive train of the electric vehicle.

The lid 130 can couple with one or more electrolytes 125 disposed within the inner region 120 of the housing 105. For example, the lid 130 can couple with at least one electrolyte 125 through one or more tabs. A first polarity tab 185 can couple the electrolyte 125 (e.g., positive region of the electrolyte 125) with the first polarity layer 135 of the lid 130. The first polarity tab 185 can extend from a first polarity region of the electrolyte 125 to at least one surface of the first polarity layer 135. The first polarity tab 185 can extend through a second polarity orifice of the second polarity layer 140 and a second insulated orifice of the insulating layer 145 to electrically couple the first polarity region of the electrolyte 125 with the first polarity layer 135. A second polarity tab 190 can couple the electrolyte 125 with the second polarity layer 140 of the lid 130. The second polarity tab 190 can extend from a second polarity region of the electrolyte 125 to at least one surface (e.g., bottom surface) of the second polarity layer 140. The second polarity tab 190 can electrically couple the second polarity region of the electrolyte 125 with the second polarity layer 140. When the second polarity layer 140 of the lid 130 is coupled with the electrolyte 125 through the second polarity tab 190, the housing 105 may include non-conductive material.

The lid 130 can include at least one insulation material 155. The at least one insulation material 155 can separate or electrically isolate the first polarity layer 135 from the second polarity layer 140. The insulation material 155 may include dielectric material. For example, the lid 130 can include a stacked configuration or arrangement with the first polarity layer 135 forming a first or top layer, the insulating layer 145 forming a second or middle layer, and the second polarity layer 140 forming a third or bottom layer. In the stacked configuration, the insulation material 155 can be disposed between the first polarity layer 135 of the lid 130 and the second polarity layer 140 of the lid 130. The insulation material 155 can electrically insulate the first polarity layer 135 of the lid 130 from the second polarity layer 140 of the lid 130. Thus, the lid 130 can include a first polarity surface area and a second polarity surface area corresponding to the first polarity layer 135 and the second polarity layer 140, respectively. An insulation material 155 may be disposed between an inner surface of the housing 105 and the electrolytes 125 disposed within the inner region 120 of the housing 105 to electrically insulate the housing 105 from the electrolytes 125. An insulation material 155 may be disposed between at least one surface of the lid 130 (e.g., bottom surface) and at least one surface of the electrolytes 125 (e.g., top surface) disposed within the inner region 120 of the housing 105 to electrically insulate one or more portions of the lid 130 from the electrolytes 125.

The insulating layer 145 can include one or more extrusions 195. For example, one or more extrusions 195 can be formed on or into the first surface 410 of the insulting layer 145. One or more extrusions 195 can be formed on or into the second surface 415 of the insulting layer 145. The extrusions 195 can include a cross-sectional profile formed into the first insulating layer 145. The extrusions 195 can include a hollow cavities or slots formed into different portions of the insulating layer 145 to form a cross-sectional profile for the first insulating layer 145. The extrusions 195 can create a sleeve around the extruded cylinder 225. The extrusion 195 can be or include a hollow extrusion with a curved inner cross section to create a seal bead between the first insulating layer 145 and the outside diameter of the cylinder 225. The seal can be a hermetic seal that provides an airtight or moisture tight barrier. The extrusions 195 of the insulating layer 145 can provide an airtight seal between the first insulating layer 145 and the first polarity layer 135 via compression force. The extrusions 195 of the insulating layer 145 can provide an airtight seal between the first insulating layer 145 and the second polarity layer 140 via compression force. The extrusions 195 of the insulating layer 145 can prevent air ingress into the battery cell or leakage of internal components between the first insulating layer 145 and the first polarity layer 135. The extrusions 195 of the insulating layer 145 can prevent air ingress into the battery cell or leakage of internal components between the first insulating layer 145 and the second polarity layer 140.

The lid 130 can include the first polarity layer 135, the insulating layer 145, and the second polarity layer 140 in a stacked arrangement or stacked configuration. For example, the first polarity layer 135, the insulating layer 145, and the second polarity layer 140 aligned with respect to each other. For example, at least one edge surface of the first polarity layer 135 can be aligned with at least one edge surface of the insulating layer 145 and at least one edge surface of the second polarity layer 140. At least one edge surface of the insulating layer 145 can be aligned with at least one edge surface of the first polarity layer 135 and at least one edge surface of the second polarity layer 140. At least one edge surface of the second polarity layer 140 can be aligned with at least one edge surface of the insulating layer 145 and at least one edge surface of the first polarity layer 135. The first polarity layer 135, the insulating layer 145, and the second polarity layer 140 can be formed having the same dimensions (e.g., thickness, diameter) not including any orifices or protruding regions formed in the respective layers. For example, each of the first polarity layer 135, the insulating layer 145, and the second polarity layer 140 can be formed having a circular (or disk) shape and have the same diameter and same thickness. The first polarity layer 135, the insulating layer 145, or the second polarity layer 140 can be formed having one or more different dimensions (e.g., thickness, diameter) from at least one of the first polarity layer 135, the insulating layer 145, or the second polarity layer 140.

The battery cell 100 can include at least one crimped edge 150. For example, the housing 105 can include one or more crimped edges 150 to house, retain, hold, secure, or seal the lid 130 to the first end 110 of the housing 105. The crimped edge 150 can be formed at the first end 110 of the battery cell 100. For example, the crimped edge 150 can include an end portion or end region of the first end 110 of the housing 105 that has been crimped, bent, or otherwise manipulated to form over at least one surface (e.g., top surface) of the lid 130. The crimped edge 150 can be formed such that the respective crimped edge bends over (or are crimped over) the surface of the lid 130 to secure the lid 130 and seal the battery cell 100. The crimped edge 150 may include at least one surface (e.g., top surface) having a predetermined pattern that increases a surface area of the respective surface of the crimped edge 150.

The crimped edge 150 of the first end 110 of the housing 105 can fold, pinch, be bent towards or engage with the lid 130. The crimped edge 150 can be disposed about at least one side (e.g., side surface) or at least one surface (e.g., top surface) of the lid 130 to hold the lid 130 in place, such as but not limited to, hold the lid 130 in position against a surface (e.g., top surface) of the electrolyte 125 or an insulation material 155 disposed between the lid 130 and the electrolyte 125 and seal the battery cell 100. The crimped edge 150 can have a length from its respective outer diameter to its respective inner diameters in a range of 0.8 mm to 3 mm (the length can vary within or outside this range) and can span or cover portions of the lid 130 in a range of 360 degrees. The thickness or length from the outer diameter to the inner diameter of the crimped edge 150 can be formed to be similar or the same as the thickness of the housing 105 (e.g., 0.15 mm to 0.35 mm). The seal formed by the lid 130 and crimped edge 150 can be hermetic or fluid resistant so that the electrolyte 125 does not leak from its location within the housing 105. The lid 130 can be spaced a distance from the electrolyte 125 with the distance corresponding to a thickness of a portion of an insulation material 155 disposed between the lid 130 and the electrolyte 125.

At least one gasket 160 (e.g., sealing element) can be disposed to couple the lid 130 with the first end 110 of the housing 105. The gasket 160 can house, retain, hold, secure, seal, or otherwise include the lid 130. The gasket 160 can couple with edge surfaces of each of the first polarity layer 135, the second polarity layer 140, and the insulating layer 145. For example, the gasket 160 can include a first crimped edge 165 that can be crimped toward, in contact with or otherwise applies a pressure (e.g., compresses down on) a first surface (e.g., top surface) of the first polarity layer 135 and a second crimped edge 170 that can be crimped toward, in contact with or otherwise applies a pressure (e.g., compresses down on) a second surface (e.g., bottom surface) of the second polarity layer 140. The first crimped edge 165 and second crimped edge 170 of the gasket 160 can compress the first polarity layer 135, the second polarity layer 140, and the insulating layer 145 together or otherwise hold the first polarity layer 135, the second polarity layer 140, and the insulating layer 145 together. The gasket 160 can include a gasket, a washer, an O-ring, a cap, a fitting, a hose coupling, or any other component to house, retain, hold, secure, or seal the lid 130 with the housing 105. The gasket 160 can couple with the lid 130 to secure or hold the lid 130 in place and seal the battery cell 100. The seal can be hermetic or sufficient to prevent leakage of the electrolyte 125 within the inner region 120 of the housing 105. For example, the gasket 160 can form the seal across the first end 110 of the housing 105 using the lid 130. The seal formed by the gasket 160 can include any type of mechanical seal, such as a hermetic seal, an induction seal, a hydrostatic seal, a hydrodynamic seal, and a bonded seal, among others. The gasket 160 can include electrically insulating material to electrically isolate portions of the lid 130 (e.g., negative layer, positive layer) from the housing 105. The gasket 160 can include thermally conductive material to allow heat to evacuate from the inner region 120 of the inner region 120 of the housing 105.

The gasket 160 can couple with the edge or side portion of the lid 130 to secure the lid 130 to the housing 105. The gasket 160 can be positioned on, touching, adjacent or proximate to (e.g., within 1 mm of) or be at least partially supported by an inner surface of the housing 105. Intervening elements such as insulative or protective layers of material can be present between adjacent or proximate elements so that the adjacent or proximate elements can be directly or indirectly in contact with each other. For example, the inner surface may be in contact with the gasket 160 or the inner surface may include an indentation that is in contact with the gasket 160 to support the gasket 160 and seal the battery cell 100. The gasket 160 can include a first gasket surface 175 that is disposed proximate to or in contact with the crimped edge 150. For example, the crimped edge 150 can be formed over the gasket 160. The crimped edge 150 can create a compressive seal between it and the surface created by the indentation holding the lid 130 and the gasket 160 in place. The gasket 160 can include a second gasket surface 180 that is disposed proximate to or adjacent to a surface (e.g., top surface) of the electrolyte 125. The gasket 160 may be held in place by inserting an indentation into the battery cell housing 105 wall at a predetermined distance (e.g., 2.5 mm to 6 mm) below the surface of the crimped edges (or surfaces) 180 around the entire circumference of the housing 105. The battery cell 100 may include multiple gaskets 160 disposed to couple the lid 130 with the first end 110 of the housing 105. The battery cell 100 may a single gasket 160 disposed along an entire outer circumference or outer edge of the lid 130 to couple the lid 130 with the first end 110 of the housing 105. The gasket 160 can be positioned within the housing 105 such that the lid 130 is disposed over the electrolyte 125. The gasket 160 can be disposed such that the gasket 160 separates or spaces the lid 130 from the electrolyte 125.

The crimped edge 150 can house, retain, hold, secure, or seal the gasket 160 and the lid 130 to the first end 110 of the housing 105. For example, the crimped edge 150 can be crimped, bent, or otherwise manipulated to form over the first gasket surface 175 (e.g., top surface) of the gasket 160. The crimped edge 150 can be formed such that the respective crimped edge bends over (or are crimped over) the surface of the gasket 160 to secure the gasket 160 to the lid 130 and seal the battery cell 100. The crimped edge 150 of the first end 110 of the housing 105 can fold, pinch, be bent towards or engages with the first gasket surface 175 of the gasket 160.

The crimped edge 150 can be disposed about first gasket surface 175 of the gasket 160 to hold the gasket 160 and the lid 130 in place, such as but not limited to, hold the gasket 160 and the lid 130 in position against a surface (e.g., top surface) of the electrolyte 125 or an insulation material 155 disposed between the gasket 160, the lid 130 and the electrolyte 125 and seal the battery cell 100. The crimped edge 150 can have a length from its respective outer diameter to its respective inner diameters in a range of 0.8 mm to 3 mm (the length can vary within or outside this range)and can span or cover portions of the gasket 160 in a range of 360 degrees. The seal formed by the gasket 160 and crimped edge 150 can be hermetic or fluid resistant so that the electrolyte 125 does not leak from its location within the housing 105.

The battery cells 100 described herein can include both the positive terminal and the negative terminal disposed at a same lateral end (e.g., the top end) of the battery cell 100. For example, the first polarity layer 135 of the lid 130 can provide a first polarity terminal (e.g., positive terminal) for the battery cell 100 at the first end 110. The second polarity layer 140 of the lid 130 can provide a second polarity terminal (e.g., negative terminal) for the battery cell 100 at the first end 110. Having both terminals, for the positive and the negative terminals on one end of the battery cell 100 can eliminate wire bonding to one side of the battery pack and welding of a tab to another side of the battery cell 100 (e.g., the bottom end or the crimped region). In this manner, a terminal or an electrode tab along the bottom of the battery cell 100 can be eliminated from the structure. Thus improving the pack assembly process by making it easier to bond the wire to each of the first polarity terminal (e.g., positive terminal) and the second polarity terminal (e.g., negative terminal) of the battery cell 100. For example, the battery cell 100 can be attached to a first polarity busbar by bonding at least one wire between the at least one surface of the first polarity layer 135 of the lid 130 and the first polarity busbar. The battery cell 100 can be attached to a second polarity busbar by bonding at least one wire between the second polarity layer 140 of the lid 130 and the second polarity busbar. Each battery cell 100 can be attached to the second polarity busbar by bonding at least one wire to a side surface or second end 115 (e.g., bottom surface) of the housing 105 of the battery cell 100.

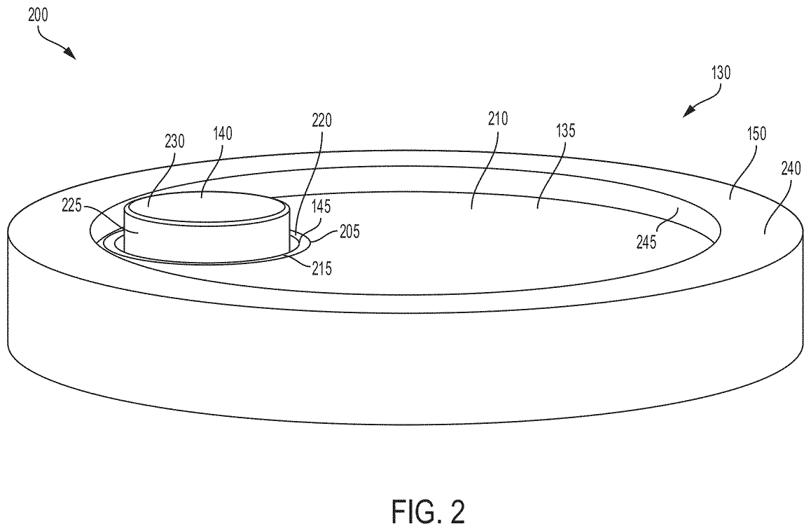

FIG. 2, among others, depicts a view 200 of a lid 130 of a battery cell 100 for a battery pack in an electric vehicle. The lid 130 includes a first polarity layer 135, a second polarity layer 140, and an insulating layer 145 disposed between the first polarity layer 135 and the second polarity layer 140. The first polarity layer 135 can be a different (e.g., opposite) polarity of the second polarity layer 140. For example, the first polarity layer 135 can include a positive polarity and the second polarity layer 140 can include a negative polarity. The first polarity layer 135 can include a negative polarity and the second polarity layer 140 can include a positive polarity.

The first polarity layer 135 can form an outer area or outer portion of the lid 130. The first polarity layer 135 can form a top layer of the lid 130 in a stacked configuration or stacked arrangement. For example, the first polarity layer 135 can include an exposed surface 210 (e.g., top surface, first surface) that can form or provide a first polarity terminal for the battery cell 100. The exposed surface 210 (also referred to herein as first surface) of the first polarity layer 135 can be exposed at the first end 110 of the battery cell 100 to provide a conductive surface to bond at least one wire having a first end coupled with at least one surface of a first polarity busbar of a battery pack of an electric vehicle and a second end couple with the exposed surface 210 of the first polarity layer 135. The first polarity layer 135 can include electrically conductive material. For example, the first polarity layer 135 can include, but not limited to, a metallic material, aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The first polarity layer 135 can be formed having a shape corresponding to the shape of the housing 105. For example, the first polarity layer 135 can be formed having a circular, ovular, elliptical, rectangular, or square shape. The first polarity layer 135 can have a diameter in a range from 15 mm to 24 mm (e.g., 18 mm) not including a first polarity orifice 205. The diameter of the first polarity layer 135 can vary within or outside this range. For example, the diameter of the first polarity layer 135 can be selected based in part on the diameter or dimensions (e.g., thickness) of the housing 105 of the battery cell 100. The first polarity layer 135 can have a thickness (e.g., vertical length) in a range from 0.3 mm to 0.9 mm (e.g., 0.6 mm). The thickness of the first polarity layer 135 can vary within or outside this range.

The first polarity layer 135 can include a first polarity orifice 205. The first polarity orifice 205 can include or be formed as a hole, aperture, or opening formed through the first polarity layer 135. The first polarity orifice 205 can have a diameter in a range from 0.5 mm to 2 mm (e.g., 1.4 mm). The diameter of the first polarity orifice 205 can vary within or outside this range. For example, the diameter of the first polarity orifice 205 can be selected based in part on the diameter or dimensions (e.g., thickness) of the insulating layer 145 or a protruding second polarity region 225 of the second polarity layer 140.

The insulating layer 145 can form a middle area, middle portion or middle layer between portions of the first polarity layer 135 and portions of the second polarity layer 140. For example, the insulating layer 145 can be disposed between portions of the first polarity layer 135 and portions of the second polarity layer 140 in a stacked configuration or stacked arrangement. The insulating layer 145 can include non-conductive material. For example, the insulating layer 145 can include, but not limited to, polymer material, insulation material, plastic material, epoxy material, FR-4 material, polypropylene materials, or formed materials. The insulating layer 145 can be formed having a shape corresponding to the shape of the housing 105. For example, the insulating layer 145 can be formed having a circular, ovular, elliptical, rectangular, or square shape.

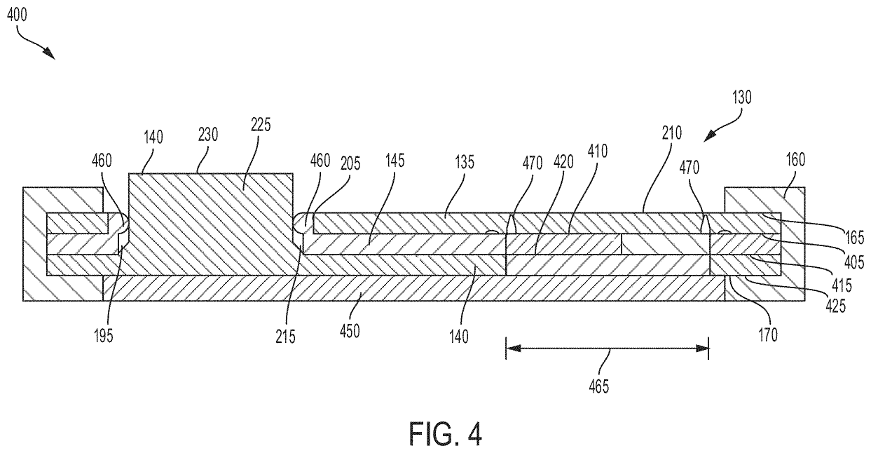

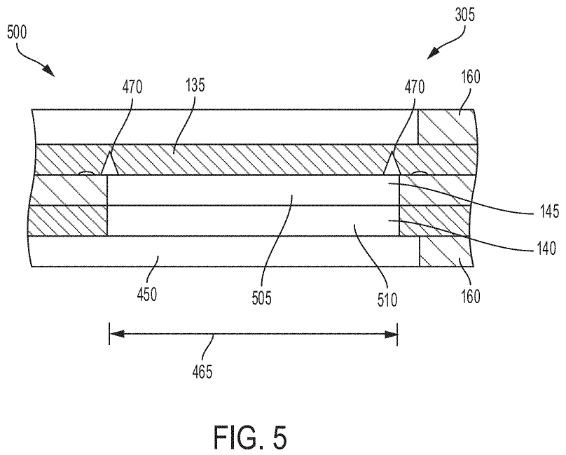

The insulating layer 145 can have a diameter in a range from 15 mm to 24 mm (e.g., 18 mm) not including a first insulated orifice 215 or a second insulated orifice (e.g., second insulated orifice 505 of FIG. 5). The diameter of the insulating layer 145 can vary within or outside this range. The insulating layer 145 can have a thickness (e.g., vertical length) in a range from 0.3 mm to 0.9 mm (e.g., 0.6 mm). The thickness of the insulating layer 145 can vary within or outside this range. The insulating layer 145 can be formed such that an exposed surface 220 (e.g., exposed from a first end 110 of the battery cell 100) of the insulating layer 145 is flush with an exposed surface 210 of the first polarity layer 135. For example, the insulating layer 145 can be formed such that the exposed surface 220 of the insulating layer 145 is at the same height or same level as the exposed surface 210 of the first polarity layer 135 as compared to a first surface 240 (e.g., top surface) of the crimped edge 150. The exposed surface 220 can correspond to a first surface or top surface of an insulated shaft region (e.g., insulated shaft region 460 of FIG. 4) of the insulating layer 145.

The insulating layer 145 can include a first insulated orifice 215. The first insulated orifice 215 can include or be formed as a hole, aperture, or opening formed through the insulating layer 145. The first insulated orifice 215 can have a diameter in a range from 0.5 mm to 1.5 mm (e.g., 1 mm). The diameter of the first insulated orifice 215 can correspond to a distance between an edge surface (or outer surface) of the first polarity orifice 205 and an outer surface of a protruding second polarity region 225 of the second polarity layer 140. The diameter of the first insulated orifice 215 can vary within or outside this range. For example, the diameter of the first insulated orifice 215 can be selected based in part on the diameter or dimensions (e.g., thickness) of the protruding second polarity region 225 of the second polarity layer 140.

The second polarity layer 140 can form an inner area, inner portion, or bottom layer of the lid 130. For example, the second polarity layer 140 can form a bottom layer of the lid 130 in a stacked configuration or stacked arrangement. The second polarity layer 140 can include electrically conductive material. For example, the second polarity layer 140 can include, but not limited to, a metallic material, aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The second polarity layer 140 can be formed having a shape corresponding to the shape of the housing 105. For example, the second polarity layer 140 can be formed having a circular, ovular, elliptical, rectangular, or square shape.

The second polarity layer 140 can have a diameter in a range from 15 mm to 24 mm (e.g., 18 mm) not including a protruding second polarity region 225 or a second polarity orifice (e.g., second polarity orifice 510 of FIG. 5). The diameter of the second polarity layer 140 can vary within or outside this range. The second polarity layer 140 can have a thickness (e.g., vertical length) in a range from 0.3 mm to 0.9 mm (e.g., 0.6 mm). The thickness of second polarity layer 140 can vary within or outside this range. The second polarity layer 140 can include a protruding second polarity region 225. The protruding second polarity region 225 can include or be formed as a cylindrical embossment that provides a second polarity terminal for the lid 130 and the battery cell 100. For example, the protruding second polarity region 225 can extend through the first insulated orifice 215 and the first polarity orifice 205. The protruding second polarity region 225 can extend through the first insulated orifice 215 such that an exposed surface 230 (e.g., top surface, first surface) of the protruding second polarity region 225 is exposed to form a negative terminal for the battery cell 100. The protruding second polarity region 225 can extend through the first polarity orifice 205, and thus though the first insulated orifice 215, with a portion of the first insulating layer 145 disposed between an edge surface of the first polarity orifice 205 and an outer surface (e.g., side surface) of the protruding second polarity region 225.

The protruding second polarity region 225 can be formed having a cylindrical, a circular, ovular, elliptical, rectangular, or square shape. The protruding second polarity region 225 can have a height with respect to the exposed surface 210 (e.g., top surface) of the first polarity layer 135 in a range from 0.5 mm to 1.5 mm (e.g., 1 mm). For example, the height of the protruding second polarity region 225 can correspond to a distance (e.g., vertical distance) the protruding second polarity region 225 extends above the exposed surface 220 of the insulating layer 145 or the exposed surface 210 of the first polarity layer 135. The height of the protruding second polarity region 225 can vary within or outside this range. The protruding second polarity region 225 of the second polarity layer 140 can have a first height with respect to a first surface 210 of the first polarity layer 135 and the first gasket surface 175 of the gasket 160 can have a second height with respect to the first surface 210 of the first polarity layer 135. The first height of the protruding second polarity region 225 can be greater than the second height of the first gasket surface 175 of the gasket 160. The protruding second polarity region 225 can have a diameter in a range from 0.5 mm to 6 mm (e.g., 4 mm). The diameter of the protruding second polarity region 225 can vary within or outside this range. The protruding second polarity region 225 can have a radius in a range from 0.25 mm to 3 mm (e.g., 2 mm). The radius of the protruding second polarity region 225 can vary within or outside this range.

A first surface 230 (e.g., top surface) or exposed surface of the protruding second polarity region 225 can form or provide a second polarity terminal for the battery cell 100. For example, the first surface 230 of the protruding second polarity region 225 can be exposed at the first end 110 of the battery cell 100 to provide a conductive surface to bond at least one wire having a first end coupled with at least one surface of a second polarity busbar of a battery pack of an electric vehicle and a second end couple with the first surface 230 of the protruding second polarity region 225.

The gasket 160 can form an outer barrier for the lid 130. For example, the gasket 160 can be formed such that it bends over, wraps around or otherwise engages at least one surface (e.g., outer surface) of the lid 130 to secure the lid 130 to the battery cell 100. The gasket 160 can be formed such that it wraps around multiple surfaces (e.g., side surface, outer edge surface, top surface) of the first polarity layer 135. The gasket 160 can have a first crimped edge 165 that extends over one or more portions of the lid 130. For example, the first crimped edge 165 of the gasket 160 can extend over portions of the exposed surface 210 of the first polarity layer 135. The first crimped edge 165 of the gasket 160 can extend over portions of the exposed surface 210 of the first polarity layer 135 and the exposed surface 220 of the insulating layer 145. The first crimped edge 165 of the gasket 160 can have a width (e.g., horizontal thickness) in a range from 0.5 mm to 1.2 mm (e.g., 0.8 mm). The width of the first crimped edge 165 of the gasket 160 can correspond to a distance the gasket 160 extends over portions, such as the exposed surface 210 of the first polarity layer 135 of the lid 130. The width of the first crimped edge 165 of the gasket 160 can vary within or outside this range. The gasket 160 can have a second crimped edge 170 that extends over one or more portions of the lid 130. For example, the second crimped edge 170 of the gasket 160 can extend over portions of a second surface of the second polarity layer 140. The second crimped edge 170 of the gasket 160 can have a width (e.g., horizontal thickness) in a range from 0.5 mm to 1.2 mm (e.g., 0.8 mm). The width of the second crimped edge 170 of the gasket 160 can correspond to a distance the gasket 160 extends over portions, such as the second surface of the second polarity layer 140 of the lid 130. The width of the second crimped edge 170 of the gasket 160 can vary within or outside this range.

The crimped edge 150 can be formed such that it bends over, wraps around or otherwise engages at least one surface (e.g., outer surface) of the gasket 160 to secure the gasket 160 to the battery cell 100. The crimped edge 150 can be formed such that it wraps around multiple surfaces (e.g., side surface, outer edge surface, top surface) of the gasket 160. The crimped edge 150 can have a first surface 240 (e.g., top surface) that extends over one or more portions of the gasket 160. For example, the first surface 240 of the crimped edge 150 can extend over portions of the first gasket surface 175 of the gasket 160. The first surface 240 of the crimped edge 150 can have a width (e.g., horizontal thickness) in a range from 0.8 mm to 3 mm (e.g., 0.8 mm). The width of the first surface 240 of the crimped edge 150 can correspond to a distance the crimped edge 150 extends over portions, such as the first gasket surface 175 of the gasket 160. The width of the first surface 240 of the crimped edge 150 can vary within or outside this range.

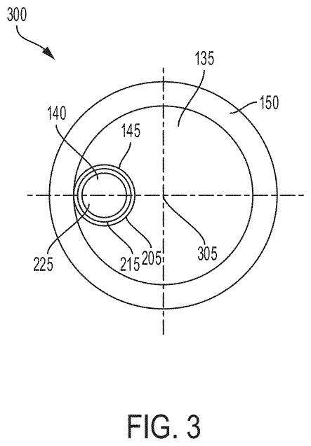

FIG. 3, among others, depicts a top view 300 of a lid 130 of a battery cell 100 of a battery pack of an electric vehicle. As depicted in FIG. 3, the protruding second polarity region 225 can be formed such that the protruding second polarity region 225 is off center with respect to a middle or center point 305 of the lid 130. For example, the protruding second polarity region 225 can be formed such that it is not in a middle region or positioned at the center point 305 of the lid 130. The positioning of the protruding second polarity region 225 can be selected to make the first surface 230 of the protruding second polarity region 225 more noticeable or stand out during an assembly stage of a manufacturing method. For example, one or more wires can be bonded to the first surface 230 of the protruding second polarity region 225 during an assembly stage of a manufacturing method and the manufacturing method can include an automated procedure. Thus, having the protruding second polarity region 225 off center with respect to a middle region or at the center point 305 of the lid 130 (e.g., not in the middle region or at the center point 305 of the lid 130) can provide a unique location for an automated system to more easily recognize and identify the first surface 230 of the protruding second polarity region 225. Thus, having the protruding second polarity region 225 off center with respect to a middle region or the center point 305 of the lid 130 can increase an accuracy of the assembly and installation of one or more battery cells 100 in a battery pack of an electric vehicle.

The protruding second polarity region 225 can be formed such that the protruding second polarity region 225 is spaced a distance from the center point 305 of the lid 130 in a range from 0.5 mm to 7.0 mm. The protruding second polarity region 225 can be formed such that the protruding second polarity region 225 is spaced a distance from an outer edge of the first polarity layer 135 in a range from 0.7 mm to 8.5 mm. The protruding second polarity region 225 can be formed such that the protruding second polarity region 225 is spaced a distance from an outer edge 245 of the crimped edge 150 in a range from 0.25 mm to 7 mm. The first polarity orifice 205 can be formed such that the first polarity orifice 205 is off center with respect to a middle region or the center point 305 of the lid 130. The first polarity orifice 205 can be formed such that the first polarity orifice 205 is spaced a distance from an outer edge of the first polarity layer 135 in a range from 0.7 mm to 8 mm. The first polarity orifice 205 can be formed such that first polarity orifice 205 is spaced a distance from an outer edge 245 of the crimped edge 150 in a range from 0.25 mm to 7 mm. The first insulated orifice 215 can be formed such that the first insulated orifice 215 is off center with respect to a middle region or the center point 305 of the lid 130. The first insulated orifice 215 can be formed such that the first insulated orifice 215 is spaced a distance from an outer edge of the first polarity layer 135 in a range from 0.7 mm to 8 mm. The first insulated orifice 215 can be formed such that the first insulated orifice 215 is spaced a distance from an outer edge 245 of the crimped edge 150 in a range from 0.5 mm to 7 mm.

FIG. 4, among others, depicts a cross-sectional view 400 of a lid 130 of a battery cell 100 for a battery pack in an electric vehicle. FIG. 4 depicts the positional relationship between the first polarity layer 135, the insulating layer 145, and the second polarity layer 140. The first polarity layer 135, the insulating layer 145, and the second polarity layer 140 can be formed in a stacked configuration or stacked arrangement. The first polarity layer 135, the insulating layer 145, and the second polarity layer 140 can be formed having the same diameter or length. The first polarity layer 135, the insulating layer 145, or the second polarity layer 140 can be formed having a different diameter or length from one or more of the first polarity layer 135, the insulating layer 145, or the second polarity layer 140. The first polarity layer 135, the insulating layer 145, and the second polarity layer 140 can be formed having the same thickness. The first polarity layer 135, the insulating layer 145, or the second polarity layer 140 can be formed having a different thickness from one or more of the first polarity layer 135, the insulating layer 145, or the second polarity layer 140. For example, the first polarity layer 135 can have a thickness (e.g., vertical length) in a range from 0.3 mm to 0.9 mm (e.g., 0.6 mm). The thickness of the first polarity layer 135 can vary within or outside this range. The second polarity layer 140 can have a thickness (e.g., vertical length) in a range from 0.3 mm to 0.9 mm (e.g., 0.6 mm). The thickness of the second polarity layer 140 can vary within or outside this range. The insulating layer 145 can have a thickness (e.g., vertical length) in a range from 0.3 mm to 0.9 mm (e.g., 0.6 mm). The thickness of the insulating layer 145 can vary within or outside this range.

The first polarity layer 135 can include a first surface 210 (e.g., top surface) and a second surface 405 (e.g., bottom surface). The top surface 210 of the first polarity layer 135 can be referred to herein as the exposed surface. For example, the top surface 210 of the first polarity layer 135 can be an exposed surface of the first end 110 of the battery cell for coupling one or more wire bonds between a first polarity busbar of a battery pack of an electric vehicle and the battery cell 100. The first crimped edge 165 of the gasket 160 can extend over a portion of the first surface 210 of the first polarity layer 135. The first crimped edge 165 of the gasket 160 can be disposed on, coupled with, adhered to, bonded to or in contact with a portion of the first surface 210 of the first polarity layer 135. For example, the first crimped edge 165 of the gasket 160 can extend over a portion of the first surface 210 of the first polarity layer 135 a distance in a range from 0.5 mm to 1.2 mm (e.g., 0.5 mm). The crimped edge 150 (as shown in FIG. 1) can extend over the first gasket surface 175 of the gasket 160. For example, a first inner surface of the crimped edge 150 can be disposed on, coupled with, adhered to, bonded to or in contact with a portion of the first gasket surface 175 of the gasket 160. For example, the first inner surface of the crimped edge 150 can extend over a portion of the first gasket surface 175 of the gasket 160 a distance in a range from 0.8 mm to 3 mm. The second surface 405 of the first polarity layer 135 can be disposed on, coupled with, adhered to, bonded to or in contact with a first surface 410 of the insulating layer 145. An adhesive layer can be disposed between the second surface 405 of the first polarity layer 135 and the first surface 410 of the insulating layer 145 to couple the second surface 405 of the first polarity layer 135 with the first surface 410 of the insulating layer 145. The first surface 410 of the insulating layer 145 can include an adhesive material to couple the second surface 405 of the first polarity layer 135 with the first surface 410 of the insulating layer 145.

The insulating layer 145 can include the first surface 410 (e.g., top surface) and a second surface 415 (e.g., bottom surface). The insulating layer 145 can be disposed between the first polarity layer 135 and the second polarity layer 140 to electrically isolate the first polarity layer 135 from the second polarity layer 140. The second surface 415 of the insulating layer 145 can be disposed on, coupled with, adhered to, bonded to or in contact with a first surface 420 of the second polarity layer 140. The insulating layer 145 can have the first surface 410 in contact with the second surface 405 of the first polarity layer 135. The first surface 410 of the insulating layer 145 can include one or more extrusions 195 to couple the first surface 410 with the second surface 405 of the first polarity layer 135. The insulating layer 145 can have the second surface 415 in contact with the first surface 420 of the second polarity layer 140. The second surface 415 of the insulating layer 145 can include one or more extrusions 195 to couple the second surface 415 with the first surface 420 of the second polarity layer 140. An adhesive layer can be disposed between the second surface 415 of the insulating layer 145 and the first surface 420 of the second polarity layer 140 to couple the second surface 415 of the insulating layer 145 with the first surface 420 of the second polarity layer 140. The second surface 415 of the insulating layer 145 can include an adhesive material to couple the second surface 415 of the insulating layer 145 with the first surface 420 of the second polarity layer 140.

The second polarity layer 140 can include the first surface 420 (e.g., top surface) and a second surface 425 (e.g., bottom surface). The second surface 425 of the second polarity layer 140 can be positioned adjacent to, above, or over a first surface of at least one electrolyte disposed within a battery cell 100. An insulating material 450 can be disposed between the second surface 425 of the second polarity layer 140 and a first surface of at least one electrolyte disposed within a battery cell 100. For example, the insulating material 450 can electrically insulate the second surface 425 of the second polarity layer 140 from the electrolyte.

The second crimped edge 170 of the gasket 160 can extend over a portion of the second surface 425 of the first polarity layer 135. For example, the second crimped edge 170 of the gasket 160 can be disposed under, coupled with, adhered to, bonded to or in contact with a portion of the second surface 425 of the second polarity layer 140. The second crimped edge 170 of the gasket 160 can extend under a portion of the second surface 425 of the second polarity layer 140 a distance in a range from 0.5 mm to 1.2 mm (e.g., 0.5 mm).

As depicted in FIG. 4, the protruding second polarity region 225 extends through the first insulated orifice 215 of the insulating layer 145 and the first polarity orifice 205 of the first polarity layer 135. The protruding second polarity region 225 can be formed as an extension of the second polarity layer 140. The protruding second polarity region 225 can be integrally formed with the second polarity layer 140. For example, the protruding second polarity region 225 can include the same material as the second polarity layer 140. The first insulated orifice 215 can be disposed between the protruding second polarity region 225 and one or more portions of the first polarity layer 135 to electrically insulate the protruding second polarity region 225 from the first polarity layer 135. For example, the first insulated orifice 215 of the insulating layer 145 can include an insulated shaft region 460 that extends into the first polarity orifice 205 of the first polarity layer 135 to electrically insulate the protruding second polarity region 225 from the first polarity layer 135. The insulated shaft region 460 can extend from the first surface 410 of the insulating layer 145 and extend through the first polarity orifice 205 of the first polarity layer 135. The insulated shaft region 460 can be disposed between an edge surface of the first polarity layer 135 and an outer surface of the protruding second polarity region 225. The exposed surface 220 of the insulating layer 145 can corresponds to a first surface or top surface of the insulated shaft region 460. For example, the insulated shaft region 460 can extend from the first surface 410 of the insulating layer 145 and be exposed at the first end 110 of the battery cell 100. The insulated shaft region 460 can include the same material as the insulating layer 145. For example, the insulated shaft region 460 can include non-conductive material. The insulated shaft region 460 can have a width (e.g., horizontal thickness) in a range from 0.2 mm to 0.6 mm (e.g., 0.4 mm). The width (or horizontal thickness) of the insulated shaft region 460 can correspond to a distance between an edge surface (or outer surface) of the first polarity orifice 205 and an outer surface of a protruding second polarity region 225 of the second polarity layer 140. The width (or horizontal thickness) of the insulated shaft region 460 can vary within or outside this range.

The first insulated orifice 215 can include one or more extrusions 195. The extrusions 195 of the first insulated orifice 215 can provide an airtight seal between the first insulated orifice 215 and the protruding second polarity region 225 via compression force. The extrusions 195 of the first insulated orifice 215 can prevent air ingress into the battery cell or leakage of internal components between the first insulated orifice 215 and protruding second polarity region 225. The insulated shaft region 460 can include one or more extrusions 195. The extrusions 195 of the insulated shaft region 460 can provide an airtight seal between the insulated shaft region 460 and the protruding second polarity region 225 via compression force. The extrusions 195 of the insulated shaft region 460 can prevent air ingress into the battery cell or leakage of internal components between the insulated shaft region 460 and protruding second polarity region 225.

The lid 130 can include a scored region 465. The scored region 465 can correspond to a scored, thinned or otherwise structurally weakened region of the first polarity layer 135. The scored region 465 can be structurally weakened as compared to other regions or portions of the first polarity layer 135 to operate as a vent during a thermal event or over pressurization of a battery cell 100 the lid 130 is coupled with. For example, the scored region 465 can be structurally weakened as compared to other regions or portions of the first polarity layer 135 to prove an electrical break point during a high voltage (e.g., over voltage) or high current (e.g., over current) conditions for a respective battery cell 100 the lid 130 is coupled with. For example, the scored region 465 of the first polarity layer 135 can break under high pressure, high voltage or high current conditions to break an electrical connection between the first polarity layer 135 and a first polarity tab 185 coupled with an electrolyte within a battery cell 100. The scored region 465 of the first polarity layer 135 can break under high pressure, high voltage or high current conditions to break an electrical connection between the first polarity layer 135 and a busbar of a battery pack of an electric vehicle the first polarity layer 135, and thus, the battery cell 100, is coupled with through one or more wire bonds. For example, the scored region 465 can operate or function as a current interrupter device (CID) for the battery cell 100 and break and electrical connection between at least one busbar of a battery pack of an electric vehicle and at least one layer (e.g., first polarity layer 135) of the lid 130.

A thickness (e.g., vertical height) of the scored region 465 of the first polarity layer 135 can be less than the thickness of other regions or portions of the first polarity layer 135. For example, the first surface 210 of the first polarity layer 135 can be scored to reduce a thickness of the scored region 465 as compared to the other regions or portions of the first polarity layer 135. The second surface 405 of the first polarity layer 135 can be scored to reduce a thickness of the scored region 465 as compared to the other regions or portions of the first polarity layer 135. The first polarity layer 135 can have a first thickness and the scored region 465 of the first polarity layer 135 can have a second thickness. The first thickness of the first polarity layer 135 can be different (e.g., less than) from the second thickness of the scored region 465. The other regions or portions of the first polarity layer 135 not including the scored region 465 can have a first thickness and the scored region 465 can have a second thickness. The second thickness of the scored region 465 can be less than the first thickness of the other regions or portions of the first polarity layer 135. The scored region 465 of the first polarity layer 135 can have a thickness in a range from 0.1 mm to 0.7 mm (e.g., 0.4 mm). The thickness of the insulating layer 145 can vary within or outside this range. The scored region 465 can have a diameter in a range from 1.0 mm to 6.0 mm (e.g., 3 mm). The scored region 465 can be a mirror image of the cylinder 225, e.g., in terms of width or diameter, located on the opposite side of center point 305, for example. The diameter of the scored region 465 can vary within or outside this range.

The scored region 465 can include at least one scoring point 470 formed into the first surface 210 of the first polarity layer 135. The scored region 465 can include at least one scoring point 470 formed into the second surface 405 of the first polarity layer 135. The scored region 465 can include multiple scoring points 470 (e.g., two or more) formed into the first surface 210 of the first polarity layer 135, the second surface 405 of the first polarity layer 135, or both the first surface 210 and the second surface 405 of the first polarity layer 135. The scoring points 470 can include cuts, indentations, incisions, or slits formed into a respective surface of the first polarity layer 135. The scoring points 470 can reduce a structural strength of the first polarity layer 135. The scored region 465 can have a reduced structural strength as compared to other regions or portions of the first polarity layer 135 due to the scoring points 470. For example, the scoring points 470 can corresponds to electrical break points that can break under high pressure, high voltage or high current conditions before other regions or portions of the first polarity layer 135 would break under the same conditions. One or more scoring points 470 can be formed into the first surface 420 of the second polarity layer 140 or the second surface 425 of the second polarity layer 140 to form a scored region within the second polarity layer 140.

The scored region 465 can be formed a predetermined distance from the protruding second polarity region 225, the first insulated orifice 215 of the insulating layer 145, and the first polarity orifice 205 of the first polarity layer 135. For example, the scored region 465 can be formed in a different position relative to the first surface 210 of the first polarity layer 135 as compared to a position of the protruding second polarity region 225, the first insulated orifice 215 of the insulating layer 145, and the first polarity orifice 205 of the first polarity layer 135.

The scored region 465 of the first polarity layer 135 can be formed 180 degrees from the protruding second polarity region 225 with respect to the first surface 210 of the first polarity layer 135. The scored region 465 of the first polarity layer 135 can be formed 180 degrees from the first insulated orifice 215 of the insulating layer 145 and the first polarity orifice 205 of the first polarity layer 135 with respect to the first surface 210 of the first polarity layer 135. The scored region 465 of the first polarity layer 135 can be formed 180 degrees from the first polarity orifice 205 of the first polarity layer 135 with respect to the first surface 210 of the first polarity layer 135. The predetermined distance, relative to the first surface 210 of the first polarity layer 135, the scored region 465 can be positioned as compared to the protruding second polarity region 225, the first insulated orifice 215 of the insulating layer 145, and the first polarity orifice 205 of the first polarity layer 135 can range from 45 degrees to 180 degrees in both directions along the first surface 210 of the first polarity layer 135.

FIG. 5, among others, depicts a cross-sectional view 500 of a scored region 465 of a first polarity layer 135 aligned with orifices formed in an insulating layer 145 and a second polarity layer 140 of a lid 130 of a battery cell 100 for a battery pack in an electric vehicle. The insulating layer 145 can include a second insulated orifice 505. The second insulated orifice 505 can include or be formed as a hole, aperture, or opening formed through the insulating layer 145. The second insulated orifice 505 can be formed such that the second insulated orifice 505 is aligned with the scored region 465 of the first polarity layer 135. For example, the second insulated orifice 505 can be formed such it is positioned under the scored region 465 of the first polarity layer 135. The second insulated orifice 505 can be formed having the same diameter (or length for square or rectangular shape) as the scored region 465 of the first polarity layer 135. For example, the second insulated orifice 505 can have a diameter in a range from 1.0 mm to 6.0 mm (e.g., 3 mm). The diameter of the second insulated orifice 505 can vary within or outside this range. For example, the diameter of the second insulated orifice 505 can be as wide as or wider than the diameter of the scored region 470 so that they do not interfere with one other or with additional components.

The second insulated orifice 505 of the insulating layer 145 can be formed a predetermined distance from the first insulated orifice 215 of the insulating layer 145 with respect to the first surface 410 or the second surface 415 of the insulating layer 145. For example, the second insulated orifice 505 of the insulating layer 145 can be formed in a different position relative to the first surface 410 or the second surface 415 of the insulating layer 145 as compared to a position of the first insulated orifice 215 of the insulating layer 145. The second insulated orifice 505 of the insulating layer 145 can be formed 180 degrees from the first insulated orifice 215 of the insulating layer 145 with respect to the first surface 410 or the second surface 415 of the insulating layer 145. The predetermined distance, relative to the first surface 410 or the second surface 415 of the insulating layer 145, the second insulated orifice 505 of the insulating layer 145 can be formed as compared to the first insulated orifice 215 of the insulating layer 145 can range from 45 degrees to 180 degrees in both directions along the first surface 410 or the second surface 415 of the insulating layer 145. The second insulated orifice 505 can include one or more extrusions 195. The extrusions 195 of the second insulated orifice 505 can provide an airtight seal between the first polarity layer 135 and the second polarity layer 140. The extrusions 195 of the second insulated orifice 505 can prevent air ingress into the battery cell or leakage of internal components between the first polarity layer 135 and the second polarity layer 140.

The second polarity layer 140 can include a second polarity orifice 510. The second polarity orifice 510 can include or be formed as a hole, aperture, or opening formed through the second polarity layer 140. The second polarity orifice 510 can be formed such that the second polarity orifice 510 is aligned with the scored region 465 of the first polarity layer 135 and the second insulated orifice 505 of the insulating layer 145. For example, the second polarity orifice 510 can be formed such it is positioned entirely or partially under the scored region 465 of the first polarity layer 135 and the second insulated orifice 505 of the second polarity layer 140. The second polarity orifice 510 can be formed having the same diameter (or length for square or rectangular shape) as the scored region 465 of the first polarity layer 135. For example, the second polarity orifice 510 can have a diameter in a range from 1.0 mm to 6.0 mm (e.g., 3 mm). The diameter of the second polarity orifice 510 can vary within or outside this range. The diameter of the second polarity orifice 510 can be as wide as or wider than the diameter of the scored region 470 so that they do not interfere with one other or with additional components.

The second polarity orifice 510 of the second polarity layer 140 can be formed a predetermined distance from the protruding second polarity region 225 of the second polarity layer 140 with respect to the first surface 420 or the second surface 425 of the second polarity layer 140. For example, the second polarity orifice 510 of the second polarity layer 140 can be formed in a different position relative to the first surface 420 or the second surface 425 of the second polarity layer 140 as compared to a position of the protruding second polarity region 225 of the second polarity layer 140. The second polarity orifice 510 of the second polarity layer 140 can be formed 180 degrees from the protruding second polarity region 225 of the second polarity layer 140 with respect to the first surface 420 or the second surface 425 of the second polarity layer 140. The predetermined distance, relative to the first surface 420 or the second surface 425 of the second polarity layer 140, the second polarity orifice 510 of the second polarity layer 140 can be formed as compared to the protruding second polarity region 225 of the second polarity layer 140 can range from 45 degrees to 180 degrees in both directions along the first surface 420 or the second surface 425 of the second polarity layer 140.

The second insulated orifice 505 and the second polarity orifice 510 can be formed as holes through the insulating layer 145 and the second polarity layer 140, respectively to allow at least one first polarity tab 185 to extend from an electrolyte 125 disposed within a battery cell 100. For example, the first polarity tab 185 can have a first end coupled with at least one surface or first polarity region of the electrolyte 125 and a second end coupled with at least one surface (e.g., second surface 405) of the first polarity layer 135. The first polarity tab 185 can extend through the second insulated orifice 505 and the second polarity orifice 510 to couple the first polarity region of the electrolyte 125 with the first polarity layer 135. By coupling the first polarity region of the electrolyte 125 with the first polarity layer 135 through the first polarity tab 185, the first polarity layer 135 can form a first polarity terminal for the battery cell 100. An insulating material 450 can be disposed within the second insulated orifice 505 and the second polarity orifice 510 to electrically insulate the first polarity tab from the second polarity layer 140. An insulating material 450 can be formed around an outer surface of the first polarity tab 185 to electrically insulate the first polarity tab 185 from the second polarity layer 140. A second polarity tab 190 can extend from a second polarity region of the electrolyte 125 to the second surface 425 of the second polarity layer 140. The second polarity tab 190 can electrically couple the second polarity region of the electrolyte 125 with the second polarity layer 140. The second polarity tab 190 can extend through the insulating material 450 disposed between the electrolyte 125 and the second polarity layer 140.

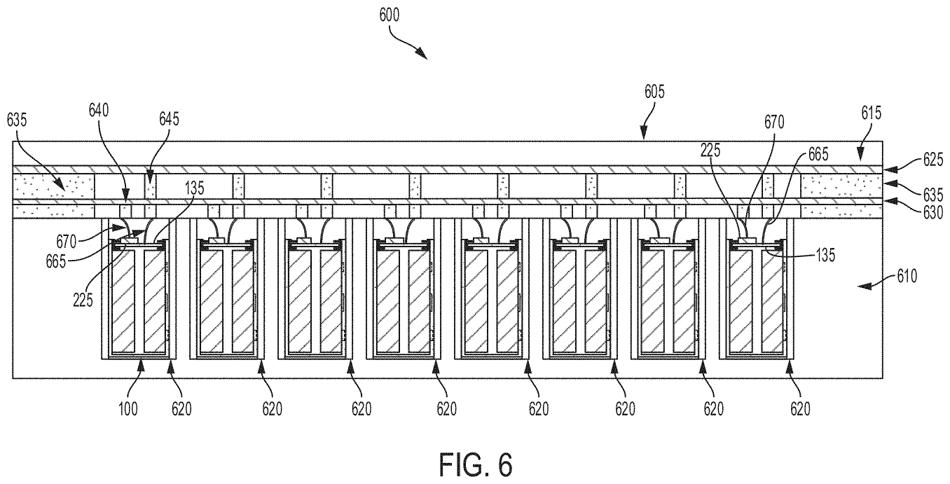

FIG. 6 depicts a cross-section view 600 of a battery pack 605 to hold a plurality of battery cells 100 in an electric vehicle. The battery cell 100 can be disposed in a battery pack 605 having multiple battery cells 100. The battery cell 100 can have an operating voltage in a range from 2.5 V to 5 V (e.g., 2.5 V to 4.2 V). The operating voltage of the battery cell 100 can vary within or outside this range. The battery cells 100 can include a lid 130 having a first polarity layer 135 forming a first polarity terminal and a protruding second polarity region 225 forming a second polarity terminal for the respective battery cells 100. For example, the first polarity layer 135 can form a first polarity terminal for the battery cell 100 to couple with the battery pack 605 and the protruding second polarity region 225 of the second polarity layer 140 can form a second polarity terminal for the battery cell 100 to couple with the battery pack 605. The first polarity layer 135 and the protruding second polarity region 225 can be positioned at the same end, here the first end 110, of the battery cell 100 to provide terminals for coupling the respective battery cell 100 to at least one busbar 625, 630 within the battery pack 605. The battery pack 605 can include a battery case 610 and a capping element 615. The battery case 610 can be separated from the capping element 615. The battery case 610 can include or define a plurality of holders 620. Each holder 620 can include a hollowing or a hollow portion defined by the battery case 610. Each holder 620 can house, contain, store, or hold a battery cell 100. The battery case 610 can include at least one electrically or thermally conductive material, or combinations thereof. The battery case 610 can include one or more thermoelectric heat pumps. Each thermoelectric heat pump can be thermally coupled directly or indirectly to a battery cell 100 housed in the holder 620. Each thermoelectric heat pump can regulate temperature or heat radiating from the battery cell 100 housed in the holder 620. The first bonding element 665 and the second bonding element 670 can extend from the battery cell 100 through the respective holder 620 of the battery case 610. For example, the first bonding element 665 or the second bonding element 670 can couple with the first polarity layer 135 and the protruding second polarity region 225, respectively.

Between the battery case 610 and the capping element 615, the battery pack 605 can include a first busbar 625, a second busbar 630, and an electrically insulating layer 635. The first busbar 625 and the second busbar 630 can each include an electrically conductive material to provide electrical power to other electrical components in the electric vehicle. The first busbar 625 (sometimes referred to herein as a first current collector) can be connected or otherwise electrically coupled to the first bonding element 665 extending from each battery cell 100 housed in the plurality of holders 620 via a bonding element 645. The bonding element 645 can include electrically conductive material, such as but not limited to, a metallic material, aluminum, or an aluminum alloy with copper. The bonding element 645 can extend from the first busbar 625 to the first bonding element 665 extending from each battery cell 100. The bonding element 645 can be bonded, welded, connected, attached, or otherwise electrically coupled to the first bonding element 665 extending from the battery cell 100. The first bonding element 665 can define the first polarity terminal for the battery cell 100. The first bonding element 665 can include a first end coupled with a surface of the first polarity layer 135 of the lid 130 and a second end coupled with a surface of the bonding element 645. The first busbar 625 can define the first polarity terminal for the battery pack 605. The second busbar 630 (sometimes referred to as a second current collector) can be connected or otherwise electrically coupled to the second bonding element 670 extending from each battery cell 100 housed in the plurality of holders 620 via a bonding element 640. The bonding element 640 can include electrically conductive material, such as but not limited to, a metallic material, aluminum, or an aluminum alloy with copper. The bonding element 640 can extends from the second busbar 630 to the second bonding element 670 extending from each battery cell 100. The bonding element 640 can be bonded, welded, connected, attached, or otherwise electrically coupled to the second bonding element 670 extending from the battery cell 100. The second bonding element 670 can define the second polarity terminal for the battery cell 100. The second bonding element 670 can include a first end coupled with a surface of the protruding second polarity region 225 of the lid 130 and a second end coupled with a surface of the bonding element 640. The second busbar 630 can define the second polarity terminal for the battery pack 605.

The first busbar 625 and the second busbar 630 can be separated from each other by the electrically insulating layer 635. The electrically insulating layer 635 can include any electrically insulating material or dielectric material, such as air, nitrogen, sulfur hexafluoride (SF6), porcelain, glass, and plastic (e.g., polysiloxane), among others to separate the first busbar 625 from the second busbar 630. The electrically insulating layer 635 can include spacing to pass or fit the first bonding element 665 connected to the first busbar 625 and the second bonding element 670 connected to the second busbar 630. The electrically insulating layer 635 can partially or fully span the volume defined by the battery case 610 and the capping element 615. A top plane of the electrically insulating layer 635 can be in contact or be flush with a bottom plane of the capping element 615. A bottom plane of the electrically insulating layer 635 can be in contact or be flush with a top plane of the battery case 610.

FIG. 7 depicts a cross-section view 700 of an electric vehicle 705 installed with a battery pack 605. The battery pack 605 can include at least one battery cell 100 having a lid 130. The lid 130 can include a first polarity layer 135 forming a first polarity terminal and a protruding second polarity region 225 forming a second polarity terminal for the respective battery cell 100. For example, the first polarity layer 135 and the protruding second polarity region 225 can be positioned at the same end, here the first end 110, of the battery cell 100 to provide terminals for coupling the respective battery cell 100 to a busbar 625, 630 within the battery pack 605. The battery cells 100 described herein can be used to form battery packs 605 residing in electric vehicles 705 for an automotive configuration. For example, the battery cell 100 can be disposed in the battery pack 605 and the battery pack 605 can be disposed in the electric vehicle 705. An automotive configuration includes a configuration, arrangement or network of electrical, electronic, mechanical or electromechanical devices within a vehicle of any type. An automotive configuration can include battery cells for battery packs in vehicles such as electric vehicles (EVs). EV s can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned. Thus, the electric vehicle 705 can include an autonomous, semi-autonomous, or non-autonomous human operated vehicle. The electric vehicle 705 can include a hybrid vehicle that operates from on-board electric sources and from gasoline or other power sources. The electric vehicle 705 can include automobiles, cars, trucks, passenger vehicles, industrial vehicles, motorcycles, and other transport vehicles. The electric vehicle 705 can include a chassis 710 (e.g., a frame, internal frame, or support structure). The chassis 710 can support various components of the electric vehicle 705. The chassis 710 can span a front portion 715 (e.g., a hood or bonnet portion), a body portion 720, and a rear portion 725 (e.g., a trunk portion) of the electric vehicle 705. The front portion 715 can include the portion of the electric vehicle 705 from the front bumper to the front wheel well of the electric vehicle 705. The body portion 720 can include the portion of the electric vehicle 705 from the front wheel well to the back wheel well of the electric vehicle 705. The rear portion 725 can include the portion of the electric vehicle 705 from the back wheel well to the back bumper of the electric vehicle 705.

The battery pack 605 that includes at least one battery cell 100 having a lid 130 can be installed or placed within the electric vehicle 705. For example, the battery pack 605 can couple with a drive train unit of the electric vehicle 705. The drive train unit may include components of the electric vehicle 705 that generate or provide power to drive the wheels or move the electric vehicle 705. The drive train unit can be a component of an electric vehicle drive system. The electric vehicle drive system can transmit or provide power to different components of the electric vehicle 705. For example, the electric vehicle drive train system can transmit power from the battery pack 605 to an axle or wheels of the electric vehicle 705. The battery pack 605 can be installed on the chassis 710 of the electric vehicle 705 within the front portion 715, the body portion 720 (as depicted in FIG. 7), or the rear portion 725. A first busbar 625 (e.g., first polarity busbar) and a second busbar 630 (e.g., second polarity busbar) can be connected or otherwise be electrically coupled with other electrical components of the electric vehicle 705 to provide electrical power from the battery pack 605 to the other electrical components of the electric vehicle 705. For example, the first busbar 625 can couple with a first polarity layer 135 of a lid of at least one battery cell 100 of the battery pack 605 through a wirebond or bonding element (e.g., bonding element 645 of FIG. 6). The second busbar 630 can couple with a protruding second polarity region 225 of a lid 130 of at least one battery cell 100 of the battery pack 605 through a wirebond or bonding element (e.g., bonding element 640 of FIG. 6).

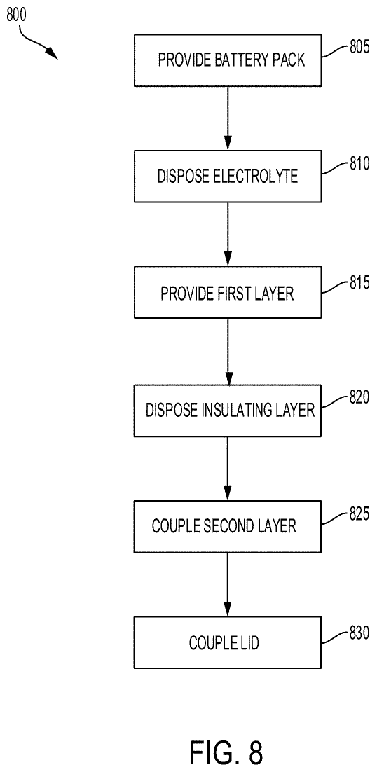

FIG. 8, among others, depicts a flow diagram of a method 800 of providing a battery cell 100 of a battery pack 605 to power an electric vehicle 705. The method 800 can include providing a battery pack 605 (ACT 805). For example, the method 800 can include providing a battery pack 605 having a battery cell 100. The battery cell 100 can include a housing 105 that includes a first end 110 and a second end 115. The housing 105 can be formed having or defining an inner region 120. The battery cell 100 can be a lithium ion battery cell, a nickel-cadmium battery cell, or a nickel-metal hydride battery cell. The battery cell 100 can be part of a battery pack 605 installed within a chassis 710 of an electric vehicle 705. For example, the battery cell 100 can be one of multiple battery cells 100 disposed within a battery pack 605 of the electric vehicle 705 to power the electric vehicle 705. The housing 105 can be formed from a cylindrical casing with a circular, ovular, elliptical, rectangular, or square base or from a prismatic casing with a polygonal base.

The method 800 can include disposing an electrolyte 125 (ACT 810). For example, method 800 can include disposing an electrolyte 125 in the inner region 120 defined by the housing 105. The electrolyte 125 can be disposed in the inner region 120 defined by the housing 105 of the battery cell 100. A single electrolyte 125 can be disposed within the inner region 120 or multiple electrolytes 125 (e.g., two or more) can be disposed within the inner region 120. The electrolytes 125 can be positioned within the inner region 120 such that they are spaced evenly from each other. For example, the electrolytes 125 can be positioned within the inner region 120 such that they are not in contact with each other. One or more insulation materials 155 may be disposed between different electrolytes 125 within the same or common inner region 120. The electrolytes 125 can be positioned within the inner region 120 such that they are spaced a predetermined distance from an inner surface of the housing 105. For example, insulation materials 155 may be disposed between different inner surfaces of the housing 105 and the electrolytes 125 within the inner region 120 to insulate the housing 105 from the electrolytes 125. Thus, a distance the electrolytes 125 are spaced from the inner surface of the housing 105 can correspond to a thickness of the insulation materials 155. An insulating material 450 can electrically insulate portions or surfaces of the housing 105 from the electrolyte 125. For example, an insulating material 450 can electrically insulate portions or surfaces of a lid 130 from the electrolyte 125. The insulating material 450 can be disposed over a top surface of the electrolyte 125 and between the electrolyte 125 and portions of a lid 130. For example, the insulating material 450 can be disposed between the electrolyte 125 and a second polarity layer 140 of the lid 130.

The method 800 can include providing a first layer 135 (ACT 815). For example, method 800 can include providing a first polarity layer 135 having a first polarity orifice 205 and a scored region 465. The first polarity layer 135 can form a first layer of a lid 130 of the battery cell 100. The first polarity layer 135 can be disposed as an outer area or outer portion of the lid 130. The first polarity layer 135 can be formed from electrically conductive material. The first polarity layer 135 can be formed having the same shape as the housing 105 or a shape to conform to the shape of the housing 105. For example, the first polarity layer 135 can be formed having a circular, ovular, elliptical, rectangular, or square shape.

A first polarity orifice 205 can be formed through the first polarity layer 135. For example, the first polarity orifice 205 can be formed as a hole, aperture, or opening formed through the first polarity layer 135. The first polarity layer 135 can be positioned such that a first surface 210 of the first polarity layer 135 corresponds to an exposed surface 210 (e.g., top surface, first surface) of the first polarity layer 135. The first surface 210 can form or provide a first polarity terminal for the battery cell 100. For example, the first surface 210 of the first polarity layer 135 can be exposed at the first end 110 of the battery cell 100 to provide a conductive surface to bond at least one wire (e.g., bond element 665) having a first end coupled with at least one surface of a first polarity busbar 625 of a battery pack 605 of an electric vehicle 705 and a second end coupled with the first surface 210 of the first polarity layer 135.

Providing the first layer 135 can include forming a scored region 465 on the first polarity layer 135. For example, a region or portion of the first layer 135 can be scored, thinned or otherwise structurally weekend to from a scored region 465. The scored region 465 can be structurally weakened as compared to other regions or portions of the first polarity layer 135 to operate as a vent during a thermal event or over pressurization of a battery cell 100 the lid 130 is coupled with. The scored region 465 can be formed having a thickness (e.g., vertical height) that is less than the thickness of other regions or portions of the first polarity layer 135. For example, the first surface 210 of the first polarity layer 135 can be scored to reduce a thickness of the scored region 465 as compared to the other regions or portions of the first polarity layer 135. The second surface 405 of the first polarity layer 135 can be scored to reduce a thickness of the scored region 465 as compared to the other regions or portions of the first polarity layer 135. The other regions or portions of the first polarity layer 135 not including the scored region 465 can have a first thickness and the scored region 465 can have a second thickness. The second thickness of the scored region 465 can be less than the first thickness of the other regions or portions of the first polarity layer 135. At least one scoring point 470 can be formed into the first surface 210 of the first polarity layer 135 or formed into the second surface 405 of the first polarity layer 135. Forming the scoring point 470 can include forming a cut, indentation, incision or slit into the first surface 210 of the first polarity layer 135 or formed into the second surface 405 of the first polarity layer 135. The scored region 465 can include multiple scoring points 470 (e.g., two or more) formed into the first surface 210 of the first polarity layer 135, the second surface 405 of the first polarity layer 135, or both the first surface 210 and the second surface 405 of the first polarity layer 135. The scoring points 470 can reduce a structural strength of the first polarity layer 135. For example, the scoring points 470 can corresponds to electrical break points that can break under high voltage or high current conditions before other regions or portions of the first polarity layer 135 would break under the same conditions.

The method 800 can include disposing an insulating layer 145 (ACT 820). For example, method 800 can include disposing or coupling an insulating layer 145 with at least one surface of the first polarity layer 135. The insulating layer 145 can be disposed under or coupled with a second surface 405 of the first polarity layer 135. For example, an adhesive material can be disposed between a first surface 410 of the insulating layer 145 and the second surface 405 of the first polarity layer 135 to couple the insulating layer 145 with the first polarity layer 135. Disposing the insulating layer 145 can include forming a middle area or middle region between portions of the first polarity layer 135 and a second polarity layer 140. For example, the insulating layer 145 can be disposed between portions of the of the first polarity layer 135 and portions of the second polarity layer 140 to electrically insulate the first polarity layer 135 from the second polarity layer 140. The insulating layer 145 can be formed from non-conductive material, such as but not limited to, polymer material. The insulating layer 145 can be formed having a shape corresponding to the shape of the housing 105. For example, the insulating layer 145 can be formed having a circular, ovular, elliptical, rectangular, or square shape.

A first insulated orifice 215 and a second insulated orifice 505 can be formed through the insulating layer 145. For example, the first insulated orifice 215 and a second insulated orifice 505 can each be formed as a hole, aperture, or opening formed through the insulating layer 145. The first insulated orifice 215 can be formed a predetermined distance from the second insulated orifice 505 with respect to at least one surface 410, 415 of the insulating layer 145. The first insulated orifice 215 and the second insulated orifice 505 can be formed at opposed ends of the insulating layer 145. For example, the first insulated orifice 215 can be formed 180 degrees from the second insulated orifice 505 with respect to at least one surface 410, 415 of the insulating layer 145. The first insulated orifice 215 can be formed having the same diameter as the second insulated orifice 505. The first insulated orifice 215 can be formed having a different diameter from the second insulated orifice 505.

The method 800 can include coupling a second layer 140 (ACT 825). For example, method 800 can include coupling a second polarity layer 140 with at least one surface of the insulating layer 145 such that the insulating layer 145 is disposed between the first polarity layer 135 and the second polarity layer 140 to electrically insulate the first polarity layer 135 from the second layer 140. A first surface 420 of the second polarity layer 140 can be disposed under or coupled with a second surface 415 of the insulating layer 145. An adhesive material can be disposed between the second surface 415 of the insulating layer 145 and the first surface 420 of the second polarity layer 140 to couple the insulating layer 145 with the second polarity layer 140. The second polarity layer 140 can be positioned to form an inner area or inner portion of the lid 130. The second polarity layer 140 can be formed using electrically conductive material. The second polarity layer 140 can be formed having a shape corresponding to the shape of the housing 105. For example, the second polarity layer 140 can be formed having a circular, ovular, elliptical, rectangular, or square shape.

The second polarity layer 140 can be formed having a protruding second polarity region 225. For example, the protruding second polarity region 225 can be integrally formed with the second polarity layer 140. The protruding second polarity region 225 can be formed as an extension of the second polarity layer 140. The protruding second polarity region 225 can be positioned to be aligned with orifices of the other layers of the lid 130. For example, coupling the second layer 140 can include disposing a protruding second polarity region 225 of second polarity layer 140 through the first insulated orifice 215 of the insulating layer 145 and the first polarity orifice 205 of the first polarity layer 135. The protruding second polarity region 225 can extend through the first insulated orifice 215 such that an exposed surface 230 (e.g., top surface) of the protruding second polarity region 225 is exposed to form a second polarity terminal for the battery cell 100. The exposed surface 230 of the protruding second polarity region 225 can be exposed at the first end 110 of the battery cell 100 to provide a conductive surface to bond at least one wire (e.g., bond element 670) having a first end coupled with at least one surface of a second polarity busbar 630 of a battery pack 605 of an electric vehicle 705 and a second end coupled with the exposed surface 230 of the protruding second polarity region 225.

A second polarity orifice 510 can be formed through the second polarity layer 140. For example, the second polarity orifice 510 can be formed as a hole, aperture, or opening formed through the first polarity layer 135. The second polarity orifice can be positioned such that the second polarity orifice 510 is aligned (e.g., complete or partial overlap) with orifices of other layers of the lid 130. For example, coupling the second layer 140 can include aligning the second polarity orifice 510 of the second polarity layer 140 with the scored region 465 of the first polarity layer 135 and the second insulated orifice 505 of the insulating layer 145.

The method 800 can include coupling a lid 130 (ACT 830). For example, the method 800 can include coupling a lid 130 to the first end 110 of the housing 105. The lid 130 can include the first polarity layer 135, the second polarity layer 140, and the insulating layer 145 disposed between the first polarity layer 135 and the second polarity layer 140. The lid 130 can couple with the first end 110 of the housing 105 using a gasket 160 to seal the battery cell 100. For example, coupling the lid can include crimping at least one edge of the gasket 160 over edges surfaces of each of the first polarity layer 135, the second polarity layer 140, and the insulating layer 145 to couple the first polarity layer 135, the second polarity layer 140, and the insulating layer 145 together. At least one gasket 160 can couple with an outer edge of the lid 130 and outer edges of the first polarity layer 135, the second polarity layer 140, and the insulating layer 145 to couple the lid 130 to the first end 110 of the housing 105. The gasket 160 can hold or positioned the lid 130 such that the lid 130 is spaced a predetermined distance from one or more surfaces (e.g., top surface) of the electrolyte 125 disposed within the inner region 120 of the housing 105. Coupling the lid 130 to the first end 110 of the housing 105 can include crimping the first end 110 of the housing 105 to form a crimped edge 150. For example, the first end 110 of the housing 105 can be crimped to form a crimped edge 150 that is disposed about the at least one surface of the gasket 160 and the lid 130. The crimped edge 150 can be formed to couple the gasket 160 with the first end 110 of the housing 105 and position at least one surface of the gasket 160 adjacent to or opposing at least a portion of the electrolyte 125. The crimped edge 150 can form a portion of a top surface of the battery cell 100.

Coupling the lid 130 can include disposed a first polarity tab 185 between a first polarity region of the electrolyte 125 and the first polarity layer 135 of the lid 130. The first polarity tab 185 can be disposed through the second insulated orifice 505 of the insulating layer 145 and the second polarity orifice 510 of the second polarity layer 140 to couple the first polarity region of the electrolyte 125 and the first polarity layer 135. For example, coupling the lid 130 can include electrically coupling, through the first polarity tab 185, the first polarity region of the electrolyte 125 with the first polarity layer 135 of the lid 130. The first polarity tab 185 can include a first end that is soldered or welded with the first polarity region of the electrolyte 125 and a second end that is soldered or welded with a second surface 405 of the first polarity layer 135. The first polarity tab 185 can extend from a first polarity region of the electrolyte 125 to the second surface 405 of the first polarity layer 135. The first polarity tab 185 can extend through the second polarity orifice 510 of the second polarity layer 140 and the second insulated orifice 505 of the insulating layer 145 to electrically couple the first polarity region of the electrolyte 125 with the first polarity layer 135. The first polarity tab 185 can couple the electrolyte 125 with the first polarity layer 135 of the lid 130 such that the first polarity layer 135 functions as a first polarity (e.g., positive) terminal for the battery cell 100. The first polarity tab 185 can be disposed within or embedded within an insulating material 450 spacing the electrolyte 125 from the lid 130. For example, the first polarity tab 185 can be disposed such that it extends through the insulating material 450 to couple the electrolyte 125 with the first polarity layer 135.

Coupling the lid 130 can include disposed a second polarity tab 190 between a second polarity region of the electrolyte 125 and the second polarity layer 140 of the lid 130. The second polarity tab 190 can be disposed through the insulating material 450 to couple the second polarity region of the electrolyte 125 and the second polarity layer 140. For example, coupling the lid can include electrically coupling, through the second polarity tab 190, the second polarity region of the electrolyte 125 with the second polarity layer 140 of the lid 130. The second polarity tab 190 can include a first end that is soldered or welded with the second polarity region of the electrolyte 125 and a second end that is soldered or welded with a second surface 425 of the second polarity layer 140. The second polarity tab 190 can extend the second polarity region of the electrolyte 125 to the second surface 425 of the second polarity layer 140 to electrically couple the second polarity region of the electrolyte 125 with the second polarity layer 140. The second polarity tab 190 can couple the electrolyte 125 with the second polarity layer 140 of the lid 130 such that the second polarity layer 140 functions as a second polarity (e.g., positive) terminal for the battery cell 100. For example, the protruding second polarity region 225 of the second polarity layer 140 can function as a second polarity (e.g., positive) terminal for the battery cell 100.

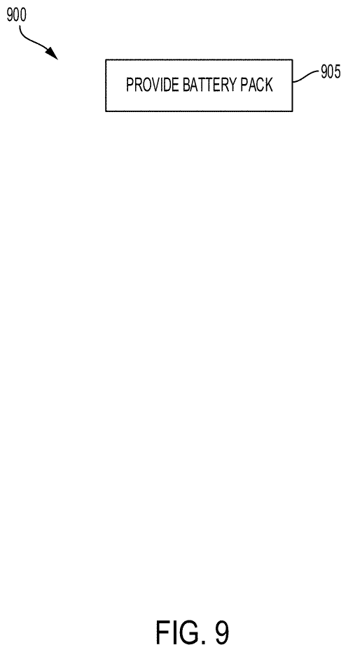

FIG. 9 depicts a method 900. The method 900 can include providing a battery pack 605 having at least one battery cell 100 for electric vehicles 705 (ACT 905). The battery pack 605 can include at least one battery cell 100. The battery cell 100 can include a housing 105 having a first end 110 and a second end 115. The housing 105 can define an inner region 120. An electrolyte 125 can be disposed in the inner region 120 defined by the housing 105. A lid 130 can be coupled with a first end 110 of the housing 105. The lid 130 can include a first polarity layer 135 having a first polarity orifice 205 and a scored region 465. The lid 130 can include an insulating layer 145 having a first insulated orifice 215 and a second insulated orifice 505. The lid 130 can include a second polarity layer 140 having a protruding second polarity region 225 that extends through the first insulated orifice 215 of the insulating layer 145 and the first polarity orifice 205 of the first polarity layer 135. The second polarity layer 140 can have a second polarity orifice 510. The second polarity orifice 510 can be aligned (e.g., complete or partial overlap) with the scored region 465 of the first polarity layer 135 and the second insulated orifice 505 of the insulating layer 145. The insulating layer 145 can be disposed between the first polarity layer 135 and the second polarity layer 140 to electrically insulate the first polarity layer 135 from the second layer 140. A gasket coupled to edges surfaces of each of the first polarity layer 135, the second polarity layer 140, and the insulating layer 145. The gasket can hold the first polarity layer 135, the second polarity layer 140, and the insulating layer 145 together.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and 13” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example the voltage across terminals of battery cells can be 5V or greater than 5V and the battery cell 100 can be or include a 21700 type battery cell. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery cell of a battery pack to power an electric vehicle, the battery cell comprising:
a housing having a first end and a second end, the housing defining an inner region;
an electrolyte disposed in the inner region defined by the housing; and
a lid coupled with a first end of the housing, the lid comprising:
a first polarity layer having a first polarity orifice and a scored region;
an insulating layer having a first insulated orifice and a second insulated orifice;
a second polarity layer having a protruding second polarity region that extends through the first insulated orifice of the insulating layer and the first polarity orifice of the first polarity layer;
the second polarity region having a second polarity orifice, the second polarity orifice aligned with the scored region of the first polarity layer and the second insulated orifice of the insulating layer;
the insulating layer disposed between the first polarity layer and the second polarity layer to electrically insulate the first polarity layer from the second layer; and
a gasket coupled to edge surfaces of each of the first polarity layer, the second polarity layer, and the insulating layer, the gasket holds the first polarity layer, the second polarity layer, and the insulating layer together.

2. The battery cell of claim 1, comprising:
the second polarity orifice of the second polarity layer formed 180 degrees from the protruding second polarity region of the second polarity layer with respect to a first surface of the second polarity layer.

3. The battery cell of claim 1, comprising:
the first insulated orifice of the insulating layer having an insulated shaft region that extends into the first polarity orifice to electrically insulate the protruding second polarity region from the first polarity layer.

4. The battery cell of claim 1, comprising:
the second insulated orifice of the insulating layer formed 180 degrees from the first insulated orifice of the insulating layer with respect to a first surface of the insulating layer.

5. The battery cell of claim 1, comprising:
the insulating layer having a first surface in contact with at least one surface of the first polarity layer, the first surface having one or more extrusions to couple with the at least one surface of the first polarity layer; and
the insulating layer having a second surface in contact with at least one surface of the second polarity layer, the second surface having one or more extrusions to couple with the at least one surface of the second polarity layer.

6. The battery cell of claim 1, comprising:
the scored region of the first polarity layer formed 180 degrees from the first polarity orifice of the first polarity layer with respect to a first surface of the first polarity layer.

7. The battery cell of claim 1, comprising:
the first polarity layer having a first thickness; and
the scored region of the first polarity layer having a second thickness, the first thickness different from the second thickness.

8. The battery cell of claim 1, comprising:
the first polarity layer having a circular shape;
the insulating layer having a circular shape; and
the second polarity layer having a circular shape.

9. The battery cell of claim 1, comprising:
the first polarity layer, the insulating layer, and the second polarity layer aligned with respect to each other such that at least one edge surface of the first polarity layer is aligned with at least one edge surface of the insulating layer, and the at least one edge surface of the insulating layer is aligned with at least one edge surface of the second polarity layer.

10. The battery cell of claim 1, comprising:
the first polarity layer, the insulating layer, and the second polarity layer having the same diameter.

11. The battery cell of claim 1, comprising:
the gasket having at least one crimped edge that couples with edge surfaces of the first polarity layer, the insulting layer, and the second polarity layer.

12. The battery cell of claim 1, comprising:
the protruding second polarity region of the second polarity layer has a first height with respect to a first surface of the first polarity layer; and
the gasket has a second height with respect to the first surface of the first polarity layer, the first height greater than the second height.

13. The battery cell of claim 1, comprising:
the protruding second region of the second polarity layer forms a second polarity terminal for the battery cell; and

14. The battery cell of claim 1, comprising:
a second polarity tab extending from a second polarity region of the electrolyte to at least one surface of the second polarity layer, the second polarity tab electrically coupling the second polarity region of the electrolyte with the second polarity layer.

15. The battery cell of claim 1, comprising:
the first polarity layer forms a first polarity terminal for the battery cell.

16. The battery cell of claim 1, comprising:
a first polarity tab extending from a first polarity region of the electrolyte to at least one surface of the first polarity layer, the first polarity tab extending through the second polarity orifice of the second polarity layer and the second insulated orifice of the insulating layer to electrically couple the first polarity region of the electrolyte with the first polarity layer.

17. The battery cell of claim 1, comprising:
the battery cell disposed in a battery pack having multiple battery cells, the first polarity layer forming a first polarity terminal for the battery cell to couple with the battery pack and the protruding second polarity region of the second polarity layer forming a second polarity terminal for the battery cell to couple with the battery pack.

18. The battery cell of claim 1, comprising:
the battery cell disposed in a battery pack and the battery pack disposed in an electric vehicle.

19. A method of providing a battery cell of a battery pack to power an electric vehicle, the method comprising:
providing a battery pack having a battery cell, the battery cell having a housing that includes a first end and a second end and defines an inner region;
disposing an electrolyte in the inner region defined by the housing; and
coupling a lid with a first end of the housing, coupling the lid comprises:
providing a first polarity layer having a first polarity orifice and a scored region;
coupling an insulating layer with at least one surface of the first polarity layer, the insulating layer having a first insulated orifice and a second insulated orifice;
coupling a second polarity layer with at least one surface of the insulating layer such that the insulating layer is disposed between the first polarity layer and the second polarity layer to electrically insulate the first polarity layer from the second layer;
disposing a protruding second polarity region of second polarity layer through the first insulated orifice of the insulating layer and the first polarity orifice of the first polarity layer, the second polarity region having a second polarity orifice;
aligning the second polarity orifice of the second polarity region with the scored region of the first polarity layer and the second insulated orifice of the insulating layer; and
crimping at least one edge of a gasket over edge surfaces of each of the first polarity layer, the second polarity layer, and the insulating layer to couple the first polarity layer, the second polarity layer, and the insulating layer together.

20. An electric vehicle, comprising:
a battery pack having a battery cell, the battery cell comprising:
a housing having a first end and a second end, the housing defining an inner region;
an electrolyte disposed in the inner region defined by the housing;
a lid coupled with a first end of the housing, the lid comprising:
a first polarity layer having a first polarity orifice and a scored region;
an insulating layer having a first insulated orifice and a second insulated orifice;
a second polarity layer having a protruding second polarity region that extends through the first insulated orifice of the insulating layer and the first polarity orifice of the first polarity layer;
the second polarity layer having a second polarity orifice, the second polarity orifice aligned with the scored region of the first polarity layer and the second insulated orifice of the insulating layer;
the insulating layer disposed between the first polarity layer and the second polarity layer to electrically insulate the first polarity layer from the second layer; and
a gasket coupled with edge surfaces of each of the first polarity layer, the second polarity layer, and the insulating layer, the gasket holds the first polarity layer, the second polarity layer, and the insulating layer together.
